(19) United States
(12) Patent Application Publication
(10) Pub. No.: US 2026/0350345 A1
(43) Pub. Date: Nov. 5, 2026

(54) MACHINE-LEARNING ARCHITECTURE FOR HANDLING A DOUBLE-DEPENDENCY PROBLEM

(71) Applicant: STARBUCKS CORPORATION, Seattle, WA (US)

(72) Inventors: Yifei Chen, Toronto Ontario (CA); Bryan H. Noreen, Apex, NC (US); Bhagyesh Phanse, Cumberland, RI (US); Bingjie An, Kirkland, WA (US); Andrew Nyenya, Fontana, CA (US)

(73) Assignee: STARBUCKS CORPORATION, Seattle, WA (US)

(21) Appl. No.: 19/529,450

(22) Filed: Feb. 4, 2026

Related U.S. Application Data
(60) Provisional application No. 63/797,293, filed on Apr. 30, 2025.

(51) Int. Cl. G06N 3/04; G06N 3/08; G06Q 30/0601

(52) U.S. Cl. CPC G06N 3/04; G06N 3/08; G06Q 30/06311

(57) ABSTRACT

A machine-learning architecture (MLA) can generate a modifier recommendation for a target base object. In some examples, the MLA can include an embedding layer that generates an embedded set of previously selected modifiers, an embedded set of base object features, and an embedded set of candidate modifier features. The MLA can also include an average embedding layer that generates an average embedding of the embedded set of previously selected modifiers; a concatenation layer that concatenates the average embedding with the embedded set of base object features and the embedded set of candidate modifier features, to thereby produce a concatenated embedding; and a feed-forward neural network layer that receives the concatenated embedding as input and generates dense embeddings as output. The MLA can further include an output layer that receives the dense embeddings as input and generates a final score for the candidate modifier based on the dense embeddings.

### CROSS-REFERENCE TO RELATED APPLICATIONS

This claims the benefit of and priority to U.S. Provisional Patent Application No. 63/797,293, filed Apr. 30, 2025 and titled “MACHINE-LEARNING ARCHITECTURE FOR HANDLING A DOUBLE-DEPENDENCY PROBLEM,” the entirety of which is hereby incorporated by reference herein.

### TECHNICAL FIELD

The present disclosure relates generally to machine learning. More specifically, but not by way of limitation, this disclosure relates to a machine-learning architecture designed for handling a double-dependency problem, which may arise in the context of a modifier recommendation system.

### BACKGROUND

Machine learning is a subset of artificial intelligence that enables computer systems to learn from data, identify patterns, and make decisions with minimal human intervention. Machine learning systems typically involve a model (e.g., a neural network) that is trained using labeled or unlabeled datasets to perform specific tasks such as classification, prediction, optimization, or anomaly detection. Common machine-learning methods include supervised learning, unsupervised learning, semi-supervised learning, and reinforcement learning. Supervised learning relies on labeled datasets to train models to predict outputs based on inputs, while unsupervised learning focuses on finding patterns or structures within unlabeled data. Semi-supervised learning combines aspects of both approaches, and reinforcement learning enables systems to learn optimal actions through trial and error by interacting with their environment.

### BRIEF DESCRIPTION OF THE DRAWINGS

FIG. 1 shows a block diagram of an example of a system with a machine-learning architecture according to some aspects of the present disclosure.

FIGS. 2A-B show an example of the machine-learning architecture according to some aspects of the present disclosure.

FIG. 3 shows examples of the cross-product layers of the machine-learning architecture according to some aspects of the present disclosure.

FIG. 4 shows a flowchart of an example of a process for training the machine-learning architecture according to some aspects of the present disclosure.

FIG. 5 shows an example of positive and negative sampling for creating training data according to some aspects of the present disclosure.

FIG. 6 shows a block diagram of an example of a computing system usable to implement some aspects of the present disclosure.

### DETAILED DESCRIPTION

Machine-learning architectures are widely utilized in recommendation systems to suggest objects adapted to users' preferences based on historical data. Conventional recommendation systems are typically designed to recommend finalized products, such as clothing items, food items, or video games. These systems analyze the user's past interactions to predict future preferences. The underlying machine-learning models for such systems are optimized to address “single-dependency problems,” where recommendations depend exclusively on the user's historical preferences. While effective for recommending finalized products, these systems struggle with scenarios requiring recommendations for modifiers (e.g., customizations) applied to a selected base object.

In contrast to single-dependency problems, modifier recommendation systems must address “double-dependency problems.” Double-dependency problems arise when recommendations depend not only on the user's preferences but also on the characteristics of the selected base object. For example, if a user selects an iced coffee as the base object, the system may recommend modifiers such as whipped cream, caramel drizzle, or oat milk. These recommendations must account for the user's historical preferences alongside the compatibility of the modifiers with the iced coffee. The complexity increases further because different base objects have distinct sets of valid modifiers. For instance, modifiers for an iced coffee (e.g., whipped cream or vanilla syrup) differ entirely from modifiers for a bagel (e.g., cream cheese or butter). This creates a combinatorial explosion in potential recommendations, making double-dependency problems computationally challenging.

Existing machine-learning architectures often fail to adequately address these challenges. Their training processes and models are typically optimized for single-dependency scenarios, leaving them ill-equipped to handle the intricate relationships between users, base objects, and modifiers. Furthermore, the need for real-time recommendations exacerbates the technical challenges, as computational efficiency must be balanced with accuracy. Accordingly, there exists a need for machine-learning architectures capable of handling double-dependency problems in a manner that is both accurate and computationally efficient.

The present disclosure provides a machine-learning architecture specifically designed to overcome the limitations of conventional systems in addressing double-dependency problems. This architecture enables accurate and efficient recommendations of modifiers for base objects selected by users. The disclosed architecture incorporates several features that optimize its ability to model complex relationships between users, base objects, and candidate modifiers, while maintaining computational efficiency suitable for real-time applications.

For example, the machine-learning architecture can embed three feature sets: (1) the user's historical modifier preferences, (2) the selected base object, and (3) candidate modifiers. This embedding process ensures that the system can comprehensively model the relationships among these elements. To further enhance its predictive capabilities, the machine-learning architecture may employ an average embedding layer to aggregate user preferences, concatenation layers to unify feature embeddings and encodings, and cross-product layers to capture complex interactions between the user's preferences and the base object-modifier combinations. By leveraging these advanced components, the machine-learning architecture can accurately predict the suitability of modifiers for a given base object while maintaining computational efficiency. This design ensures that the system delivers high-quality, contextually relevant recommendations with minimal latency, making it ideal for real-time applications. Additionally, the efficient use of resources reduces system overhead, enabling scalability and adaptability across various deployment scenarios.

In some examples, a user's historical modifier preferences are captured by identifying their top-X most frequently selected modifiers. These top-X modifiers explicitly represent the user's primary customization behaviors and preferences. This data is derived at the customer-modifier level, as opposed to transaction records or positive/negative samples, which are captured at the customer-base object-modifier level. This approach strengthens the model's ability to memorize observed behaviors, facilitates the derivation of hidden modification preferences during model training, and mitigates overfitting—where excessive memorization compromises the model's ability to predict behavior for unmodified base objects. Additionally, it addresses the challenge of data sparsity, which can otherwise hinder effective memorization. By striking a balance between memorization and generalization, this method enables accurate recommendations for unmodified base objects, helping to solve the double-dependency problem.

The disclosed architecture is supported by a novel training process designed to optimize its performance across diverse datasets. This training process incorporates advanced techniques such as targeted negative sampling, which explicitly adds counterexamples during training. Negative samples represent modifiers that are unlikely to be selected by the user, allowing the system to learn to distinguish between relevant and irrelevant options. This approach enhances the discriminatory power of the architecture and mitigates overfitting, ensuring that the model generalizes effectively to new users and unseen scenarios. By focusing on both positive and negative examples, the training process balances memorization of user-specific behaviors with the flexibility needed to accommodate broader patterns across the user base.

As described above, one of the primary technical challenges in creating a modifier recommendation system lies in addressing the double-dependency of modifiers on both the user and the base object. Users exhibit diverse behaviors and preferences, and their interactions with base objects vary significantly, introducing considerable uncertainty for the machine-learning model to handle. Moreover, the large number of potential base objects (ranging from hundreds to thousands) exacerbates the sparsity of training data, making accurate prediction even more difficult. To overcome these challenges, the disclosed system incorporates several innovative features that enhance its performance. For example, the system can leverage the user's top customization history (e.g., their top-X most frequent modifiers) as a compact representation of their preferences, reducing the dimensionality associated with a large user base and minimizing the risk of overfitting. Additionally, the machine-learning architecture can include cross-product layers to address the double-dependency problem. A first cross-product layer can model interactions between the user's top customization history and a candidate modifier, improving the system's ability to memorize user preferences. A second cross-product layer can capture the relationship between the base object and the candidate modifier, while considering the popularity and dependency of the modifier on the base object. These cross-product layers strengthen the connections between the user, base object, and modifier, while introducing attention to the base object's context. This balanced approach enhances the system's ability to handle sparse data while maintaining generalization, enabling it to provide accurate and personalized recommendations without overfitting to specific datasets. Through these features, the disclosed system achieves a robust, real-time, high-performance recommendation pipeline that is well-suited for applications requiring both scalability and precision.

As discussed above, some examples leverage the power of generalization to predict modifier preferences for base objects that users have not previously customized. In scenarios with a large product space—such as hundreds or thousands of base objects—many base objects may lack a modification history for individual users. Traditional models struggle with this “cold-start” problem, where insufficient user history for certain base objects limits predictive accuracy. In contrast, the machine-learning architecture described here addresses this challenge effectively. For unmodified base objects that share characteristics with previously customized ones (e.g., iced brew coffee resembling an iced americano with oat milk added), the model can apply existing modification behaviors (e.g., adding oat milk) to make recommendations for similar, unmodified objects. Beyond predicting preferences for individual users, the system also incorporates the modification preferences of similar users to refine predictions. This collaborative approach enables the model to bridge gaps in user modification preferences across a broad product space, even with limited customization history. As a result, the system can deliver accurate recommendations for base objects lacking prior user-specific modifications.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

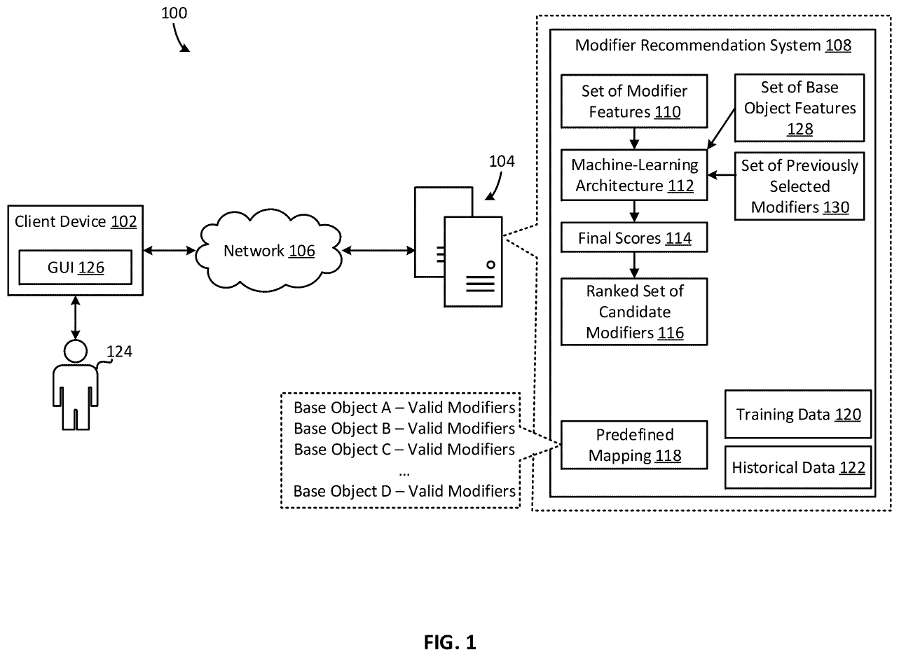

FIG. 1 shows a block diagram of an example of a system 100 with a machine-learning architecture 112 according to some aspects of the present disclosure. The system 100 is composed of several interconnected components designed to provide real-time, double-dependent recommendations to users.

The system 100 includes a client device 102, such as a laptop computer, mobile phone, desktop computer, tablet, e-reader, or wearable device such as a smart watch. The client device 102 is operated by a user 124, who interacts with the system 100 to select and customize an object (e.g., food, beverages, or other products). For example, the user 124 may operate the client device 102 to place an order for a customizable edible item, such as a beverage or food item. The selection process is facilitated by a graphical user interface (GUI) 126, which is displayed on the client device 102. The GUI 126 provides an intuitive and user-friendly interface, enabling the user 124 to browse options, select a desired base object, and explore potential modifications. The object selected by the user 124 is referred to herein as a “base object”, which serves as the foundation for customization. Base objects may vary widely in type and characteristics, but they share the common feature of being customizable through the application of one or more modifiers. This flexibility allows the system 100 to cater to diverse user preferences and scenarios, from personalizing a coffee order to customizing the features of a product.

The modifiers represent the customizations or enhancements that can be applied to the base object, enabling users to customize their selections to their specific preferences. These modifiers can take various forms depending on the type of base object. For example, in the context of food and beverages, modifiers may include add-ons, such as toppings (e.g., whipped cream, caramel drizzle, grated cheese, or spices), or additional ingredients, such as an espresso shot, flavored syrup, or ice. Modifiers can also involve substitutions, such as replacing regular milk with oat milk, ketchup with mayonnaise, or blue cheese dressing with ranch dressing. By offering a diverse range of modification options, the system 100 ensures that users can create highly personalized selections. Furthermore, modifiers can extend beyond food and beverages to other domains, such as customizing the features of a product (e.g., choosing the color, size, or material).

The system 100, through its machine-learning architecture 112, is designed to analyze the user's preferences, the characteristics of the base object, and the available modifiers to recommend the most suitable customization options for the user in real time. This capability enhances the user experience by streamlining the decision-making process and ensuring that the recommendations align with the user's unique preferences and context.

When the user 124 selects a base object, the system 100 is designed to provide tailored recommendations for modifiers that can be applied to the base object. These recommendations are generated by a server system 104, which can comprise a one or more servers, including physical machines and/or virtual machines. The server system 104 communicates with the client device 102 through a networks 106, such as a local area network and/or the Internet. Additionally, the server system 104 may be associated with a manufacturing facility responsible for creating the customized object based on the user's selections. Examples of such manufacturing facilities include cafés, restaurants, and retail stores. For instance, the server system 104 might be associated with a cafe where the user 124 can place an order for a customized beverage via the Internet. Upon receiving the order, the cafe processes the customization details provided by the system 100, prepares the beverage, and makes it available for pickup by the user. This integration of recommendation generation and manufacturing capabilities ensures a smooth and personalized user experience.

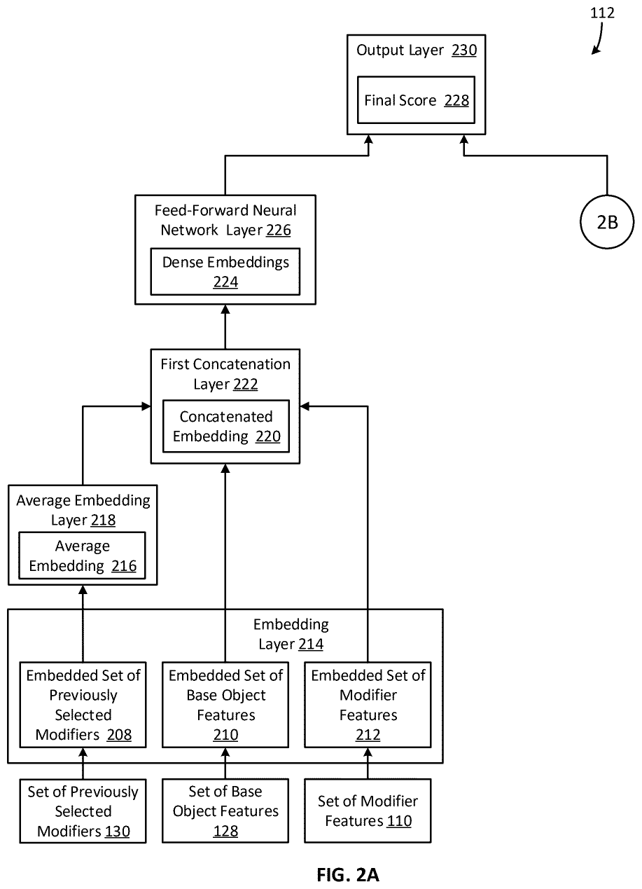

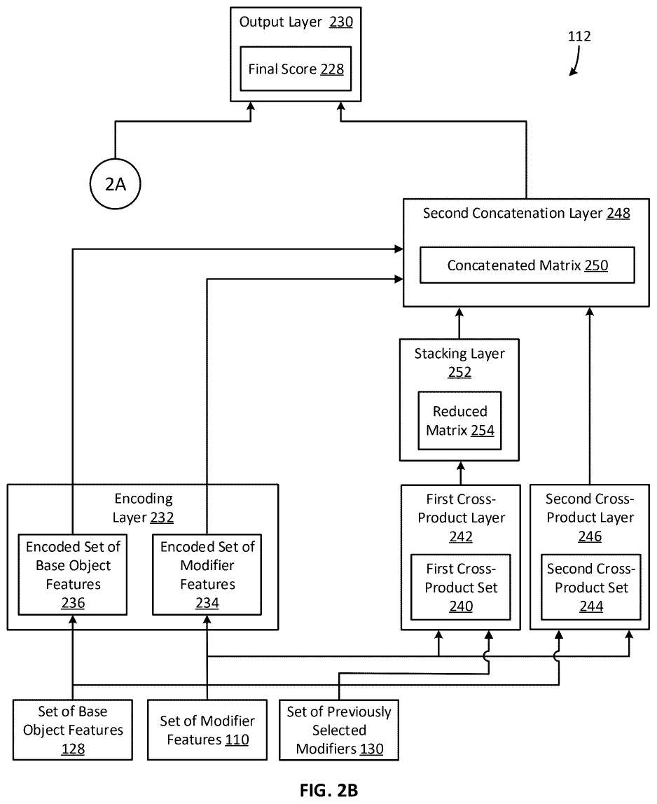

The server system 104 leverages a modifier recommendation system 108 to determine the most relevant modifiers for the selected base object. At the core of this recommendation system is a machine-learning architecture 112, which is specifically designed to handle the complexities of double-dependency problems described earlier. The machine-learning architecture 112 can include several layers, such as an embedding layer, an encoding layer, an average embedding layer, a first cross-product layer, a second cross-product layer, a first concatenation layer, a second concatenation layer, a feed-forward neural network layer, and an output layer. Each layer can include nodes that process and transform data to enable accurate and efficient predictions. The embedding layer can embed features such as the user's historical preferences, the characteristics of the base object, and the attributes of candidate modifiers. The encoding layer can encode (e.g., one-hot encode) features such as the characteristics of the base object and the attributes of candidate modifiers. The various other layers can capture intricate patterns and relationships between these embedded and encoded features, while the output layer generates scores that indicate the suitability of the candidate modifiers. A detailed example of this architecture is illustrated in FIGS. 2A-B and further explained in subsequent sections of the disclosure. By integrating this sophisticated architecture, the system can provide highly relevant recommendations in real time.

Once the user's selection of a base object is received, the modifier recommendation system 108 accesses a predefined mapping 118 to identify a set of valid modifiers associated with the selected base object. This mapping acts as a correlation framework, linking each base object to its corresponding set of valid modifiers. For example, if the selected base object is an iced coffee (e.g., “Base Object A” in FIG. 1), the predefined mapping 118 might include valid modifiers such as whipped cream, sprinkles, vanilla syrup, extra ice, cream, whole milk, oat milk, sugar, simple syrup, and cocoa powder. Conversely, if the selected base object is a bagel (e.g., “Base Object B” in FIG. 1), the valid modifiers may include butter, cream cheese, onions, and tomatoes. The valid modifiers for one base object may differ entirely from those for another, resulting in non-overlapping sets of options. The predefined mapping 118 ensures that each base object is paired with modifiers that are contextually relevant and compatible, enhancing the accuracy of the recommendations.

The valid modifiers assigned to the selected base object form a set of Y candidate modifiers, which are processed (e.g., in parallel) by the machine-learning architecture 112 to generate personalized recommendations for the user. For instance, if the user 124 selects iced coffee as the base object, the set of Y candidate modifiers can include the valid options for Base Object A, such as whipped cream, sprinkles, or vanilla syrup, while excluding modifiers associated with other base objects, such as butter or cream cheese. By narrowing the scope of analysis to only the Y candidate modifiers relevant to the selected base object, the system 100 significantly improves computational efficiency. This targeted approach minimizes unnecessary processing power and memory consumption, allowing the system to deliver real-time recommendations without delays. Moreover, it avoids evaluating irrelevant modifiers that are incompatible with the selected base object, ensuring that the user receives meaningful and practical suggestions. For example, butter would not be considered as a modifier for iced coffee, as such a combination lacks contextual relevance. This streamlined methodology enables the system 100 to focus exclusively on modifiers that align with both the user's preferences and the characteristics of the base object.

The modifier recommendation system 108 can process the set of Y candidate modifiers. To do so, the modifier recommendation system 108 can supply various inputs to the machine-learning architecture 112, such as a respective set of modifier features 110 for each candidate modifier, a set of base object features 128, and a set of previously selected modifiers 130 associated with the user 124. The set of modifier features 110 for a given candidate modifier can include one or more attributes that characterize that modifier, such as its unique identifier, style, and type. The set of base object features 128 can include one or more attributes that characterize the selected base object, such as its unique identifier, temperature, style, and type. The set of previously selected modifiers 130 can include one or more modifiers that characterize the user's historical preferences, where the one or more modifiers were previously selected by the user 124 during a predefined prior time window. In some examples, the set of previously selected modifiers 130 can be the top-X most-frequently chosen modifiers by the user 124 over the prior time window, where X is a numerical threshold (e.g., the top-30 modifiers). The prior time window could span various durations, such as the previous month or year. The modifier recommendation system 108 can derive this information from historical data 122, which includes records of past orders made by the user 124 within the specified prior time window. By providing these inputs, the modifier recommendation system 108 can ensure that the machine-learning architecture 112 receives sufficient contextual information to generate personalized and accurate recommendations.

Using the provided inputs, the machine-learning architecture 112 can generate a set of Y final scores 114 for the set of Y candidate modifiers. Each final score quantifies the likelihood that the user 124 will select a particular candidate modifier. Higher final scores can indicate a greater probability of selection, while lower scores can suggest reduced relevance. For example, the final scores may be expressed as numerical values ranging between 0.0 and 1.0, with 0.95 representing a high likelihood of user selection. Through this process, the machine-learning architecture 112 can determine the recommended modifiers not only based on the preferences of the user 124 (e.g., the user's previously selected modifiers), but also based on the base object selected by the user 124.

Once the final scores 114 are generated, the modifier recommendation system 108 may rank the Y candidate modifiers based on their scores to produce a ranked set of candidate modifiers 116. This ranking can be ordered from highest score to lowest score or vice versa, depending on the desired output format. By organizing the candidate modifiers according to their predicted relevance, the modifier recommendation system 108 can easily identify the top options for customization. The ranking process helps prioritize the candidate modifiers that are most likely to meet the user's preferences while minimizing less relevant options.

The modifier recommendation system 108 may next transmit one or more of the ranked candidate modifiers 116 to the client device 102 as recommended options. To streamline the recommendation process, the modifier recommendation system 108 may select only the top-N candidate modifiers, where N is a predefined numerical threshold (e.g., the top-5 modifiers) that is less than Y. For instance, if the user selects iced coffee as the base object, the system might recommend the three highest-scoring modifiers, such as whipped cream, vanilla syrup, and oat milk. These recommendations are displayed to the user 124 via the graphical user interface (GUI) 126 on the client device 102, allowing the user 124 to easily view and choose the modifiers they want to apply. By presenting only the most relevant options, the modifier recommendation system 108 reduces decision-making complexity and improves the user experience.

The user 124 can interact with the GUI 126 to select one or more of the recommended modifiers for customization. Once the user makes their selections, the client device 102 transmits a notification of the chosen modifiers to the server system 104. The server system 104 can then initiate the manufacturing process to create the customized object with the selected modifiers. For example, if the user orders iced coffee with whipped cream and a flavor shot, the manufacturing facility associated with the server system 104 processes the request and prepares the customized beverage accordingly. Once the final product is ready, the user 124 can obtain it from the manufacturing facility, such as picking it up at the associated café.

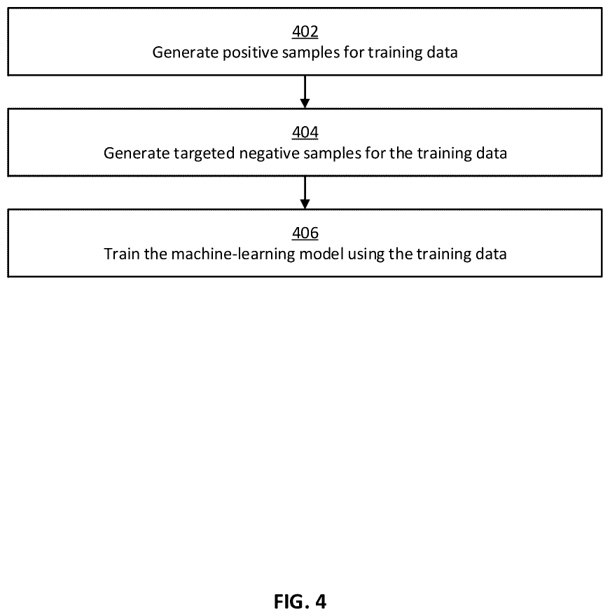

In some examples, the machine-learning architecture 112 may undergo a training process prior to its deployment and usage to generate modifier recommendations. The machine-learning architecture 112 can be trained based on training data 120. Through the training process, the machine-learning architecture 112 can be transformed from an untrained state into a trained state by tuning the weights of its internal nodes. The training process is described in greater detail later with respect to FIG. 4.

Turning now to FIGS. 2A-B, shown is an example of the machine-learning architecture 112 according to some aspects of the present disclosure. Referring first to FIG. 2A, the machine-learning architecture 112 can include an input layer (not shown for simplicity). The input layer can accept a set of previously selected modifiers 130 by the user, a set of base object features 128 for the selected base object, and a set of modifier features 110 for a candidate modifier. The input layer can accept these inputs in their original (e.g., unencoded/unembedded) form.

The input layer can next pass the three inputs to an embedding layer 214. The embedding layer 214 can transform the inputs into their respective embedded forms. In particular, the embedding layer 214 can transform the set of previously selected modifiers 130 into an embedded set of previously selected modifiers 208. The embedding layer 214 can also transform the set of base object features 128 into an embedded set of base object features 210. The embedding layer 214 can further transform the set of modifier features 110 into an embedded set of modifier features 212.

Next, the embedding layer 214 can pass the embedded set of previously selected modifiers 208 to an average embedding layer 218. The average embedding layer 218 can generate an average embedding 216 for the embedded set of previously selected modifiers 208. The average embedding 216 can represent a summary of the user's modifier history (e.g., rather than the user's explicit prior history) to reduce overfitting while capturing sufficient past historical information. The average embedding 216 can also reduce dimensionality.

The average embedding 216, the embedded set of base object features 210, and the embedded set of modifier features 212 can be passed to a first concatenation layer 222. The first concatenation layer 222 can be configured to generate a concatenated embedding 220 based on these inputs. For example, the first concatenation layer 222 can concatenate together the average embedding 216, the embedded set of base object features 210, and the embedded set of modifier features 212.

The concatenated embedding 220 can next be passed to a feed-forward neural network layer 226. The feed-forward neural network layer 226 can have its own input layer, output layer, and one or more hidden layers therebetween. The feed-forward neural network layer 226 can receive the concatenated embedding 220 as input and generate a corresponding set of dense embeddings 224 as output.

The feed-forward neural network layer 226 can next pass the dense embeddings 224 to an output layer 230. The output layer 230 can receive the dense embeddings 224 as an input. The output layer 230 can then generate a final score 228 for the candidate modifier (associated with the set of modifier features 110) based on that input. In some examples, the output layer 230 can generate the final score 228 for the candidate modifier based on one or more other inputs, such as an input derived from the layers shown in FIG. 2B. To generate the final score 228 for the candidate modifier, the output layer 230 may apply a sigmoid function to one or more of its inputs. For example, the output layer 230 may apply a sigmoid function to the dense embeddings 224 and the concatenated matrix 250 of FIG. 2B.

Referring now to FIG. 2B, as previously noted, the machine-learning architecture 112 can have an input layer which can accept the set of previously selected modifiers 130 by the user, the set of base object features 128 for the selected base object, and the set of modifier features 110 for a candidate modifier as inputs. The machine-learning architecture 112 can also include an encoding layer 232. The encoding layer 232 can receive the set of base object features 128 and the set of modifier features 110 in their original formats and translate them into respective encoded forms (e.g., via hashing and/or one-shot encoding). For example, the encoding layer 232 can transform the set of base object features 128 into an encoded set of base object features 236. The encoding layer 232 can also transform the set of modifier features 110 into an encoded set of modifier features 234. The encoding layer 232 can pass the encoded set of base object features 236 and the encoded set of modifier features 234 as inputs to a second concatenation layer 248.

The second concatenation layer 248 can accept additional inputs. For example, the machine-learning architecture 112 can also pass the set of modifier features 110 and the set of previously selected modifiers 130 as inputs to a first cross-product layer 242. The first cross-product layer 242 can help enhance memorization over the user's past modification history. The first cross-product layer 242 can generate a first cross-product set 240 by computing a first cross-product of its inputs. To control the matrix size, in some examples, the set of modifier features 110 may only consist of a single modifier feature, such as the candidate modifier's unique identification number. The first cross-product set 240 can then be passed to a stacking layer 252. The stacking layer 252 can perform a stacking operation followed by a dimension reduction. In this step, because there can be multiple cross products (e.g., 30 cross-products each with an encoding dimension of 10000, assuming there are 30 previously selected modifiers from the user's history), it can be desirable to reduce the dimension while maintaining key information. To do so, the stacking layer 252 can stack all cross products in the first cross-product set 240 (e.g., 30*10000) and then reduce its dimension by keeping the maximum value of each digit, resulting in a smaller matrix size (e.g., 1*10000). The resulting matrix, referred to herein as a “reduced matrix” 254, can be passed as another input to the second concatenation layer 248.

Additionally, the machine-learning architecture 112 can pass the set of modifier features 110 and the set of base object features 128 as inputs to a second cross-product layer 246. The second cross-product layer 246 can help address the additional dependency on the base object. The second cross-product layer 246 can generate a second cross-product set 244 by computing a second cross-product of its inputs. The second cross-product set 244 can then be passed as another input to the second concatenation layer 248.

The second concatenation layer 248 can receive the abovementioned inputs and generate a concatenated matrix 250 based on the inputs. For example, the second concatenation layer 248 can generate the concatenated matrix 250 by concatenating the encoded set of base object features 236, the encoded set of modifier features 234, the reduced matrix 254 from the stacking layer 252, and/or the second cross-product set 244 from the second cross-product layer 246. The second concatenation layer 248 can then pass the concatenated matrix 250 to the output layer 230 for use as one of the inputs in generating the final score 228 for the candidate modifier.

It will be appreciated that although the above explanations of FIGS. 2A-B refer to a single candidate modifier for simplicity, in some examples these operations may be performed as matrix operations to evaluate multiple candidate modifiers concurrently. As a result, a single execution of the machine-learning architecture 112 can be sufficient to evaluate all the candidate modifiers at the same time and produce a set of final scores for all the candidate modifiers.

It should also be appreciated that the use of ordinal terms such as “first”, “second”, “third”, etc., in the claims or description to modify an element is not intended to connote any priority, precedence, or order of one element over another, or the temporal order in which acts are performed. Rather, the ordinal terms are used merely as labels to distinguish one element having a certain name from another element having the same name (but for use of the ordinal term). For instance, the first cross-product layer 242 may be executed in parallel with the second cross-product layer 246 and/or other layers, such as the embedding layer 214 and the encoding layer 232, depending on the structure of the machine-learning architecture 112.

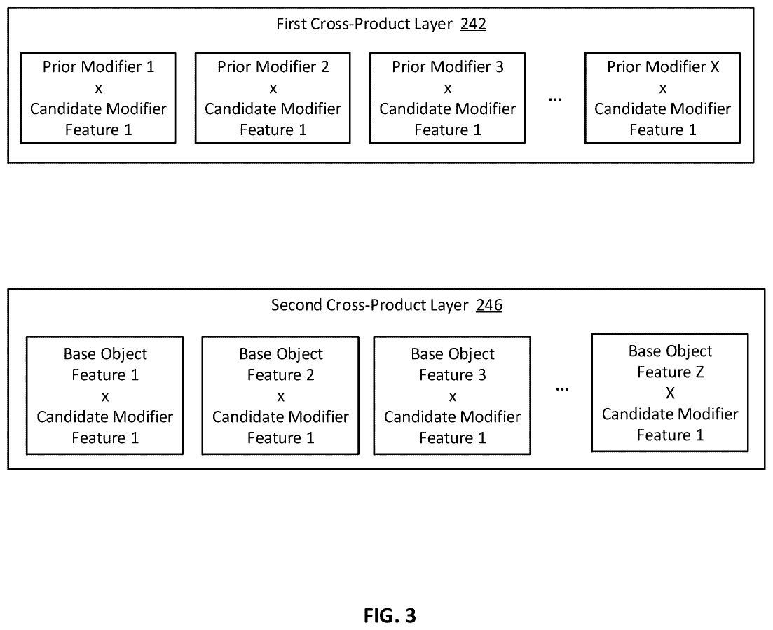

Additional details about the first cross-product layer 242 and the second cross-product layer 246 will now be described below with reference to FIG. 3. Turning now to FIG. 3, discussed earlier, the input to the machine-learning architecture 112 can include a set of X previously selected modifiers by the user during a specified prior time window. The input to the machine-learning architecture 112 can also include a set of B modifier features for a given candidate modifier. The input to the machine-learning architecture 112 can also include a set of Z base object features for a selected base object. These inputs are used in the cross-product layers 242, 246 as described below.

The first cross-product layer 242 is configured to compute a cross-product between each of the previously selected modifiers and a feature of a given candidate modifier under evaluation. For instance, if the input comprises the top 30 most-frequently selected modifiers by the user during the prior time window, the first cross-product layer 242 calculates the cross-product between each of those 30 modifiers and a feature of the candidate modifier. For simplicity, this process is shown in FIG. 3 as being performed for a single feature of the candidate modifier, but this process can similarly be performed for all of the input features of the candidate modifier. Additionally, for simplicity, this process is also shown in FIG. 3 as being applied to a single candidate modifier, but this process can similarly be performed for all the candidate modifiers under consideration. To that end, the machine-learning architecture 112 may perform vector operations. For instance, the machine-learning architecture 112 can store the X previously selected modifiers in a first vector. The machine-learning architecture 112 can also store a respective set of B modifier features for each candidate modifier in a second vector. The first cross-product layer 242 then computes a cross-product between the two vectors, enabling simultaneous evaluation of all candidate modifiers. This parallel computation significantly enhances the system's ability to process large datasets efficiently while maintaining accuracy in recommendation generation.

The second cross-product layer 246 is configured to compute a cross-product between the set of Z base object features and a feature of a given candidate modifier under evaluation. For instance, if the input comprises the 3 base object features, the second cross-product layer 246 calculates the cross-product between each of those 3 base product features and a feature of the candidate modifier. For simplicity, this process is shown in FIG. 3 as being performed for a single feature of the candidate modifier, but this process can similarly be performed for all of the input features of the candidate modifier. Additionally, for simplicity, this process is also shown in FIG. 3 as being applied to a single candidate modifier, but this process can similarly be performed for all of the candidate modifiers under consideration. To that end, the machine-learning architecture 112 may perform vector operations. For instance, the machine-learning architecture 112 can store the set of Z base object features in a first vector. The machine-learning architecture 112 can also store a respective set of B modifier features for each candidate modifier in a second vector. The second cross-product layer 246 then computes a cross-product between the two vectors, enabling simultaneous evaluation of all candidate modifiers. This parallel computation can have similar advantageous to those described above with respect to the first cross-product layer 242.

Turning now to FIG. 4, shown is a flowchart of an example of a process for training a machine-learning architecture (e.g., machine-learning architecture 112 of FIG. 1) according to some aspects of the present disclosure. Other examples may involve more operations, fewer operations, different operations, or a different sequence of operations than is shown.

In block 402, a processor generates positive samples for training data based on historical data (e.g., historical data 122 of FIG. 1) for one or more users. The historical data can describe transactions previously performed by the one or more users during a prior time window. More specifically, the processor can determine a set of modifiers that were previously selected for one or more base objects by the one or more users during the prior time window. Each of those transactions, in which a modifier was actually selected for a given base object, can be referred to as a “positive sample.” The prior time window may span a week, a month, a year, etc.

In block 404, the processor generates targeted negative samples for the training data based on the historical data for the one or more users. More specifically, if a user obtained a base object without any modification during the prior time window, there is a higher possibility that the user is not interested in the valid modifier options for that base object. Therefore, to create a negative sample, the processor can randomly select a modifier that the user has never added to that base product. This negative sample serves can better indicate the user's real negative preferences as compared to conventional techniques.

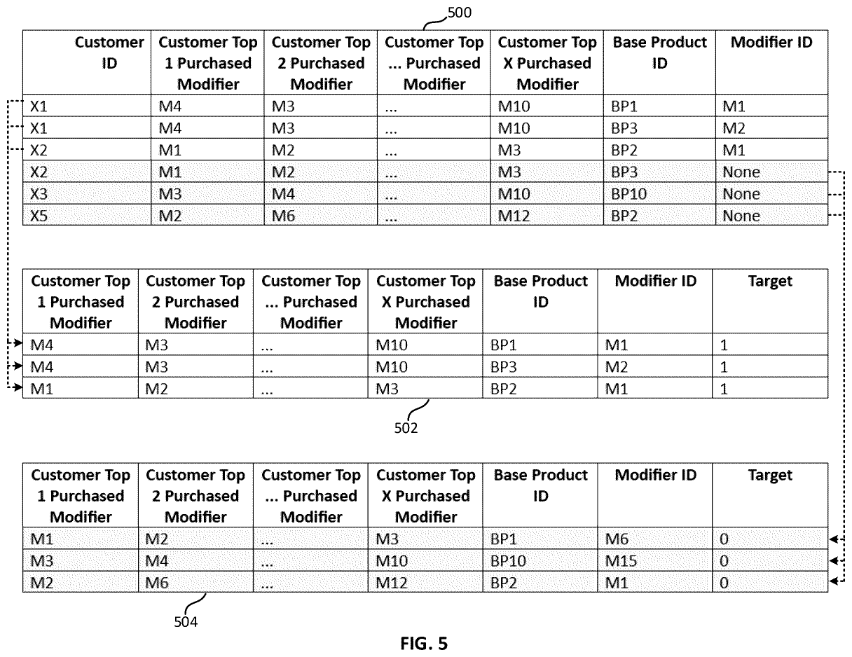

One example of the positive and negative sampling process is shown in FIG. 5. As shown, the process can begin with a transaction history 500 from which positive samples 502 and negative samples 504 can be generated. The positive samples can have their “target” field set to “1” to indicate they are positive samples, while the negative samples can have their “target” field set to “0” to indicate they are negative samples. The three positive samples 502 can be derived from the first three rows of the transaction history 500, because there is a modifier applied to a base object in those rows (e.g., in row 1, modifier M1 is applied to base object BP1). The three negative samples 504 can be derived from the last three rows of the transaction history 500.

Continuing with FIG. 4, in some examples, the processor may select at least as many negative samples for the training data as there are positive samples. For instance, if the processor generated 1000 positive samples in block 402, then the processor can select at least 1000 negative samples for the training data in block 404. This can help provide balance between the positive samples and the negative samples in the training data, so that they given a similar degree of weight in the training process.

In block 406, the processor trains the machine-learning architecture using the training data. The training process may involve tuning various internal weights of the machine-learning architecture to transform the architecture from an untrained state to a trained state.

This training process has several advantages. The training process aggregates user history at the user level, rather than at the user-base object level, which can further enhance the efficiency and generalization capabilities of the machine-learning architecture. This approach ensures a balanced trade-off between memorization and generalization, reducing the risk of overfitting. Overfitting can lead to scenarios where the architecture performs well on past user behavior but fails to provide accurate predictions for unseen or novel cases. By replacing the user with their customization history, the system effectively compresses the representation of user behavior, focusing on the most relevant and recurring preferences. This strategy significantly reduces the dimensionality of the training data, enabling the architecture to process large datasets efficiently without the computational burden of analyzing individual users for millions of users.

Unlike conventional models, which rely on exhaustive input of all users' complete purchase histories to memorize past behaviors, the disclosed approach leverages the user's past customization behavior to represent the majority of a user's preferences. This not only reduces the data size but also enhances computational efficiency, allowing the architecture to scale to handle extensive user populations. While there may be some overlap between users who exhibit similar customization preferences, this approach still captures the nuanced differences in their behavior, contributing to robust generalization. By focusing on customization interests shared across users, the system can adapt to diverse datasets and maintain accuracy in personalized recommendations. This innovative training methodology ensures the architecture is equipped to deliver high-quality recommendations for both familiar and new users, achieving scalability, precision, and adaptability.

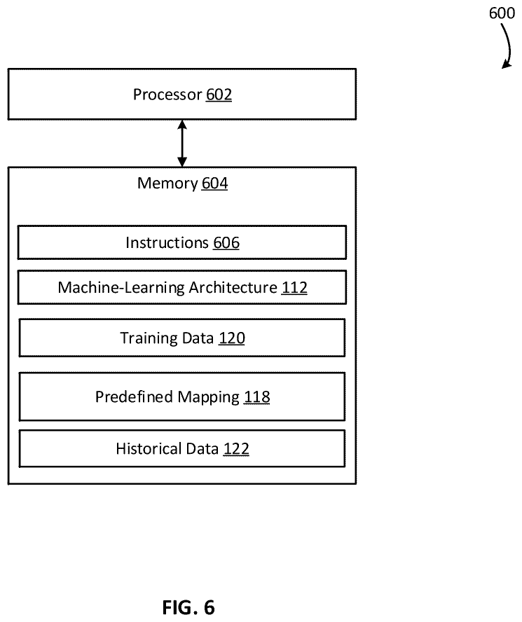

Turning now to FIG. 6, shown is a block diagram of an example of a computing system 600 usable to implement some aspects of the present disclosure. The computing system 600 includes a processor 602 communicatively coupled to a memory 604 by a bus. The processor 602 can include one processing device or multiple processing devices. Non-limiting examples of the processor 602 include a Field-Programmable Gate Array (FPGA), an application-specific integrated circuit (ASIC), a microprocessor, or any combination of these. The processor 602 can execute instructions 606 stored in the memory 604 to perform operations, such as any of the operations described above with respect to FIGS. 1-5. In some examples, the instructions 606 can include processor-specific instructions generated by a compiler or an interpreter from code written in any suitable computer-programming language, such as C, C++, C #, Python, or Java.

The memory 604 can include one memory device or multiple memory devices. The memory 604 can be volatile or non-volatile, such that the memory 604 retains stored information when powered off. Non-limiting examples of the memory 604 include electrically erasable and programmable read-only memory (EEPROM), flash memory, or any other type of non-volatile memory. At least some of the memory device includes a non-transitory computer-readable medium from which the processor 602 can read the instructions 606. A computer-readable medium can include electronic, optical, magnetic, or other storage devices capable of providing the processor 602 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 606. The memory 604 can also store the machine-learning architecture 112, training data 120, predefined mapping 118, historical data 122, or any combination of these.

The above description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium storing program code for a machine-learning architecture, the machine-learning architecture including:
an embedding layer configured to receive a set of previously selected modifiers by a user and transform the set of previously selected modifiers into an embedded set of previously selected modifiers, wherein the embedding layer is also configured to receive a set of base object features for a target base object and transform the set of base object features into an embedded set of base object features, and wherein the embedding layer is further configured to receive a set of modifier features for a candidate modifier and transform the set of modifier features into an embedded set of candidate modifier features;
an average embedding layer configured to generate an average embedding of the embedded set of previously selected modifiers;
a concatenation layer configured to concatenate the average embedding with the embedded set of base object features and the embedded set of candidate modifier features, to thereby produce a concatenated embedding;
a feed-forward neural network layer configured to receive the concatenated embedding as input and generate dense embeddings as output; and
an output layer configured to receive the dense embeddings as input and generate a final score for the candidate modifier based on the dense embeddings.

2. The non-transitory computer-readable medium of claim 1, wherein the concatenation layer is a first concatenation layer, and wherein the machine-learning architecture further comprises:
an encoding layer configured to receive the set of base object features for the target base object and transform the set of base object features into an encoded set of base object features, and wherein the encoding layer is further configured to receive the set of modifier features for the candidate modifier and transform the set of modifier features into an encoded set of modifier features;
a first cross-product layer configured to generate a first cross-product set for the set of previously selected modifiers and the set of modifier features;
a stacking layer configured to generate a reduced matrix based on the first cross-product set;
a second cross-product layer configured to generate a second cross-product set for the set of base object features and the set of modifier features; and
a second concatenation layer configured to concatenate the encoded set of base object features, the encoded set of modifier features, the reduced matrix, and the second cross-product set, to thereby generate a concatenated matrix.

3. The non-transitory computer-readable medium of claim 2, wherein the output layer is configured generate the final score based on the dense embeddings and the concatenated matrix.

4. The non-transitory computer-readable medium of claim 3, wherein the output layer is configured to generate the final score by applying a sigmoid function to the dense embeddings and the concatenated matrix.

5. The non-transitory computer-readable medium of claim 1, further storing program code that is executable by one or more processors for causing the one or more processors to:
receive, from a client device of the user, a user input indicating the target base object;
based on receiving the user input, execute the machine-learning architecture in relation to a set of candidate modifiers for the target base object to generate a set of final scores for the set of candidate modifiers;
based on the set of final scores, select the candidate modifier from among the set of candidate modifiers to use as a recommended modifier for the user; and
transmit the recommended modifier to the client device of the user.

6. The non-transitory computer-readable medium of claim 5, further storing program code that is executable by the one or more processors for causing the one or more processors to:
rank the set of candidate modifiers by the set of final scores, to thereby generate a ranked set of candidate modifiers; and
provide the ranked set of candidate modifiers to the client device of the user.

7. The non-transitory computer-readable medium of claim 5, further storing program code that is executable by the one or more processors for causing the one or more processors to, prior to executing the machine-learning architecture:
access a predefined mapping which correlates base objects to valid modifiers, each of the base objects being associated in the predefined mapping with a respective set of valid modifiers;
determine, based on the predefined mapping, the respective set of valid modifiers corresponding to the target base object; and
select the respective set of valid modifiers as the set of candidate modifiers for evaluation by the machine-learning architecture.

8. The non-transitory computer-readable medium of claim 1, further storing program code that is executable by one or more processors for causing the one or more processors to, prior to executing the machine-learning architecture:
generate positive samples from historical data;
generate negative samples from the historical data;
generate training data that includes the positive samples and the negative samples; and
train the machine-learning architecture using the training data.

9. The non-transitory computer-readable medium of claim 8, wherein each of the negative samples corresponds to a base object that was not modified by the user at least one time during a prior time window.

10. A method comprising:
receiving, by a processor, a user input indicating a target base object chosen by a user;
based on receiving the user input, executing, by the processor, a machine-learning architecture in relation to a candidate modifier for the target base object to generate a final score for the candidate modifier, wherein the machine-learning architecture includes:
an embedding layer configured to receive a set of previously selected modifiers by the user and transform the set of previously selected modifiers into an embedded set of previously selected modifiers, wherein the embedding layer is also configured to receive a set of base object features for the target base object and transform the set of base object features into an embedded set of base object features, and wherein the embedding layer is further configured to receive a set of modifier features for the candidate modifier and transform the set of modifier features into an embedded set of candidate modifier features;
an average embedding layer configured to generate an average embedding of the embedded set of previously selected modifiers;
a concatenation layer configured to concatenate the average embedding with the embedded set of base object features and the embedded set of candidate modifier features, to thereby produce a concatenated embedding;
a feed-forward neural network layer configured to receive the concatenated embedding as input and generate dense embeddings as output; and
an output layer configured to receive the dense embeddings as input and generate the final score for the candidate modifier based on the dense embeddings; and
selecting, by the processor and based on the final score, the candidate modifier as a recommended modifier for the user; and
providing, by the processor, the recommended modifier to the user.

11. The method of claim 10, wherein the concatenation layer is a first concatenation layer, and wherein the machine-learning architecture further comprises:
an encoding layer configured to receive the set of base object features for the target base object and transform the set of base object features into an encoded set of base object features, and wherein the encoding layer is further configured to receive the set of modifier features for the candidate modifier and transform the set of modifier features into an encoded set of modifier features;
a first cross-product layer configured to generate a first cross-product set for the set of previously selected modifiers and the set of modifier features;
a stacking layer configured to generate a reduced matrix based on the first cross-product set;
a second cross-product layer configured to generate a second cross-product set for the set of base object features and the set of modifier features; and
a second concatenation layer configured to concatenate the encoded set of base object features, the encoded set of modifier features, the reduced matrix, and the second cross-product set, to thereby generate a concatenated matrix.

12. The method of claim 11, wherein the output layer is configured generate the final score based on the dense embeddings and the concatenated matrix.

13. The method of claim 12, wherein the output layer is configured to generate the final score by applying a sigmoid function to the dense embeddings and the concatenated matrix.

14. The method of claim 10, further comprising:
executing the machine-learning architecture in relation to a set of candidate modifiers for the target base object to generate a set of final scores for the set of candidate modifiers;
ranking the set of candidate modifiers by the set of final scores, to thereby generate a ranked set of candidate modifiers; and
providing the ranked set of candidate modifiers to the user.

15. The method of claim 14, further comprising, prior to executing the machine-learning architecture:
accessing a predefined mapping which correlates base objects to valid modifiers, each of the base objects being associated in the predefined mapping with a respective set of valid modifiers;
determining, based on the predefined mapping, the respective set of valid modifiers corresponding to the target base object; and
selecting the respective set of valid modifiers as the set of candidate modifiers for input to the machine-learning architecture.

16. The method of claim 10, further comprising, prior to executing the machine-learning architecture:
generating positive samples from historical data;
generating negative samples from the historical data;
generating training data that includes the positive samples and the negative samples; and
training the machine-learning architecture using the training data.

17. The method of claim 16, wherein each of the negative samples corresponds to a base object that was not modified by the user at least one time during a prior time window.

18. A system comprising:
one or more processors; and
one or more memories storing program code that is executable by the one or more processors for causing the one or more processors to perform operations including:
receiving a user input indicating a target base object chosen by a user;
based on receiving the user input, executing, by the processor, a machine-learning architecture in relation to a candidate modifier for the target base object to generate a final score for the candidate modifier, wherein the machine-learning architecture includes:
an embedding layer configured to receive a set of previously selected modifiers by the user and transform the set of previously selected modifiers into an embedded set of previously selected modifiers, wherein the embedding layer is also configured to receive a set of base object features for the target base object and transform the set of base object features into an embedded set of base object features, and wherein the embedding layer is further configured to receive a set of modifier features for the candidate modifier and transform the set of modifier features into an embedded set of candidate modifier features;
an average embedding layer configured to generate an average embedding of the embedded set of previously selected modifiers;
a concatenation layer configured to concatenate the average embedding with the embedded set of base object features and the embedded set of candidate modifier features, to thereby produce a concatenated embedding;
a feed-forward neural network layer configured to receive the concatenated embedding as input and generate dense embeddings as output; and
an output layer configured to receive the dense embeddings as input and generate the final score for the candidate modifier based on the dense embeddings; and
selecting, based on the final score, the candidate modifier as a recommended modifier for the user; and
providing the recommended modifier to the user.

19. The system of claim 18, wherein the concatenation layer is a first concatenation layer, and wherein the machine-learning architecture further comprises:
an encoding layer configured to receive the set of base object features for the target base object and transform the set of base object features into an encoded set of base object features, and wherein the encoding layer is further configured to receive the set of modifier features for the candidate modifier and transform the set of modifier features into an encoded set of modifier features;
a first cross-product layer configured to generate a first cross-product set for the set of previously selected modifiers and the set of modifier features;
a stacking layer configured to generate a reduced matrix based on the first cross-product set;
a second cross-product layer configured to generate a second cross-product set for the set of base object features and the set of modifier features; and
a second concatenation layer configured to concatenate the encoded set of base object features, the encoded set of modifier features, the reduced matrix, and the second cross-product set, to thereby generate a concatenated matrix.

20. The system of claim 18, wherein the operations further comprise, prior to executing the machine-learning architecture:
generating a set of positive samples from historical data;
generating a set of negative samples from the historical data;
generating training data that includes the set of positive samples and the set of negative samples; and
training the machine-learning architecture using the training data.
